(19) United States
(12) Patent Application Publication
(10) Pub. No.: US 2025/0326405 A1
(43) Pub. Date: Oct. 23, 2025

(54) Driver Assistance System and Driver Assistance Method for a Vehicle

(71) Applicant: Bayerische Motoren Werke Aktiengesellschaft, Muenchen (DE)

(72) Inventors: Boris ISRAEL, Muenchen (DE); Walter KAGERER, Muenchen (DE); Andreas SPAETH, Lindau (DE); Benoit VANHOLME, Barcelona (ES)

(21) Appl. No.: 18/867,573

(22) PCT Filed: May 11, 2023
(86) PCT No.: PCT/EP2023/062598

§ 371 Date: Nov. 20, 2024

(30) Foreign Application Priority Data
May 24, 2022 (DE) 10 2022 113 148.3

(51) Int. Cl. B60W 60/00; B60W 40/08; B60W 50/14; G06V 20/59

(52) U.S. Cl. CPC B60W 60/0016; B60W 40/08; B60W 50/14; G06V 20/597; B60W 2040/0827; B60W 2420/403; B60W 2540/215; B60W 2540/229

(57) ABSTRACT

Please substitute the new Abstract submitted herewith for the original Abstract:

A driver assistance system (DAS) for a vehicle includes a user interface module that receives a user input to deactivate an emergency stopping function. The DAS includes a driver monitoring module that determines a driver status. The DAS includes a control module that reactivates the deactivated emergency stopping function if the driver status corresponds to a predetermined status.

### BACKGROUND AND SUMMARY

The present disclosure relates to a driver assistance system for a vehicle, a vehicle having such a driver assistance system, a driver assistance method for a vehicle, and a storage medium for carrying out the driver assistance method. The present disclosure relates in particular to reactivating an emergency stopping function of a vehicle, in particular a motor vehicle, which has been switched off by a driver.

Driver assistance systems for managing critical situations while driving are continuously gaining importance with the development of (semi-)autonomously driving vehicles. For example, a driver assistance system is described in document DE 10 2012 001 312 A1, in which an operating command can be input by means of an input device, such as a switch. If such an input takes place, a driving maneuver that can be carried out autonomously is thus triggerable. The driver assistance system in particular enables an emergency stop triggerable by the driver or a front passenger if the driver is incapable of driving.

Such driver assistance systems are often deactivatable by the driver. If the driver forgets to reactivate the driver assistance system or the driver intentionally omits to do this, hazardous situations can occur, such as collisions with other road users and/or obstacles.

It is an object of the present disclosure to specify a driver assistance system for a vehicle, a vehicle having such a driver assistance system, a driver assistance method for a vehicle, and a storage medium for carrying out the driver assistance method which can maximize a functional readiness of an emergency stopping function. In particular, it is an object of the present disclosure to avoid potential hazardous situations in road traffic.

This object is achieved by the subject matter of the independent claims. Advantageous embodiments are specified in the dependent claims.

According to at least one aspect of the present disclosure, a driver assistance system for a vehicle, in particular a motor vehicle, is specified. The driver assistance system comprises a user interface module configured to receive a user input for deactivating an emergency stopping function; a driver monitoring module configured to determine a driver status; and a control module configured to reactivate the deactivated emergency stopping function if the driver status corresponds to a predetermined status.

According to at least one aspect of the invention, the emergency stopping function is activated or armed in the background in specific situations, even if the driver has previously deactivated the emergency stopping function. For example, if the driver is identified as very fatigued, the emergency stopping function can be automatically activated or armed counter to the driver input. As a result, a functional readiness of the emergency stopping function can be maximized, by which potential hazardous situations in road traffic, such as collisions with other road users and/or obstacles, can be avoided.

The term “activation” refers in the scope of the present disclosure to arming of the emergency stopping function. In other words, the term does not refer to triggering an emergency stop. In particular with deactivated emergency stopping function, an emergency stop cannot be triggered, even if a trigger condition, such as a medical emergency, is met. With activated emergency stopping function, in contrast, an emergency stop is triggered if the trigger condition, such as a medical emergency, is met.

The term “emergency stop” refers to an autonomous driving maneuver of the vehicle in order to bring the vehicle to a standstill, for example, on a shoulder or on the roadside. For this purpose, the vehicle can independently brake and optionally steer.

The emergency stop is carried out or triggered if at least one trigger condition is met. The at least one trigger condition can in particular define a criterion, in the event of which the emergency stop is carried out. For example, the at least one trigger condition can be a detected sleep status, a state of unconsciousness, a medical emergency, an actuation of a switch by the driver or another passenger, etc. The present disclosure is not restricted to these examples, however, and additional or different suitable criteria can be defined, in the event of which an emergency stop is to be carried out.

The user interface module can comprise at least one output device and at least one input device. The user interface module can be, for example, a central information output and information input device of an infotainment system, such as a head unit. The user interface module is preferably permanently installed in the vehicle.

The at least one output device can comprise at least one display device and/or at least one loudspeaker. The at least one display device can comprise a display, in particular an LCD display, a plasma display, or an OLED display. Additionally, or alternatively, the at least one display device can comprise a projection device configured to show information directly in the field of view of the driver, in particular to project it on the windshield.

The at least one input device can comprise a touch-sensitive input device, such as a touchpad, and/or a tactile input device, such as a switch (for example, pressure switch and/or rotating switch), or other mechanically operable button elements.

The user interface module preferably comprises or is a touchscreen which provides the at least one output device and the at least one input device.

The driver monitoring module preferably comprises at least one sensor configured to register the driver and provide registered data. The at least one sensor can be an optical sensor, such as a camera, in particular an interior camera. The driver monitoring module can optionally comprise at least one light source. In some embodiments, the light source can be an infrared light source and the at least one sensor can be an infrared sensor, such as an infrared camera.

The driver monitoring module is configured to evaluate the registered data provided by the at least one sensor, such as image data. The status of the driver can be registered or determined by the evaluation of the registered data. For example, a sleep status can be detected if the driver has continuously closed his eyes.

The term “driver status” or “status of the driver” can comprise a waking status (sleeping or waking) and/or a fatigue status (fatigued or not fatigued) and/or an emotional status (for example, calm or excited) and/or a medical status (for example, unconsciousness) of the driver. In particular, the driver status relates to a fatigue (fatigued or not fatigued) and/or a fatigue level (slightly fatigued or very fatigued).

The predetermined status is preferably a fatigued status of the driver. In other words, the emergency stopping function can be reactivated when it is detected that the driver is fatigued.

The user interface module is preferably configured to output a request to reactivate the emergency stopping function if the driver status corresponds to the predetermined status; and to reactivate the emergency stopping function if a user input to reactivate the emergency stopping function is received as a response to the request. For example, in the event of a detected (for example, slight) fatigue of the driver, an acoustic and/or optical notification can be output which prompts the driver to confirm a reactivation of the emergency stopping function. If the driver confirms, the emergency stopping function can be reactivated. If the driver does not confirm, the emergency stopping function may not be reactivated or may remain deactivated.

The control module is preferably configured to reactivate the deactivated emergency stopping function automatically if the driver status corresponds to the predetermined status. In particular, the control module can reactivate the emergency stopping function directly without participation of the driver. For example, it can be detected that the driver is very fatigued, whereupon the control module can directly arm the emergency stopping function.

The driver monitoring module is preferably configured to determine a measure of the driver status, and wherein the control module is configured to execute the reactivation of the emergency stopping function based on the measure of the driver status. The measure can specify a degree or a form of a specific driver status, such as fatigue. For example, the driver monitoring module can carry out a classification or gradation of the driver status, such as fatigue, into two or more classes or levels. The two or more classes or levels can comprise, for example, “slight/minor”, “strong/severe”, and optionally “moderate”.

In some embodiments, the control module can be configured to carry out the reactivation of the emergency stopping function later the lower the measure of the driver status is. In other words, the control module can be configured to carry out the reactivation of the emergency stopping function earlier the higher the measure of the driver status is. For example, it is possible to wait longer with the reactivation of the emergency stopping function with slight fatigue than with severe fatigue.

The control module is preferably configured to output the request to reactivate the emergency stopping function if the measure of the driver status corresponds to a first measure, in particular wherein the first measure is a first fatigue status of the driver; and to reactivate the deactivated emergency stopping function automatically or directly if the measure of the driver status corresponds to a second measure, which is higher than the first measure. The first measure and the second measure are typically a fatigue or a fatigue status of the driver. If only a slight fatigue is detected, the driver can initially be asked whether the emergency stopping function is to be reactivated. However, if a severe fatigue is detected, the emergency stopping function can be activated again directly without querying the driver.

The driver monitoring module is preferably configured for a long-term observation of the driver. The control module can be configured to carry out the reactivation of the emergency stopping function based on the long-term observation of the driver. For example, in the context of the long-term observation, frequent severe fatigue states or frequent fainting attacks can be detected. In such cases, the control module can carry out the reactivation of the emergency stopping function with a low threshold, for example automatically upon starting travel or in the event of even slight fatigue.

The control module is preferably configured to reactivate the emergency stopping function for a current driving cycle and to deactivate it again for a driving cycle following the current driving cycle. In other words, the reactivation of the emergency stopping function can take place temporarily for the current driving cycle.

The control module is preferably configured to reactivate the emergency stopping function permanently for this driver if the driver status corresponds to a predetermined status. In particular, the emergency stopping function can be activated for the current driving cycle and can remain activated for one or more following driving cycles if the driver is the same.

The term “driving cycle” can be suitably defined as the period of time between a starting point and an end point. For example, the starting point can be a start of the engine or driving away at a starting location. Similarly, the end point can be parking the vehicle or a route destination.

According to a further independent aspect of the present disclosure, a vehicle, in particular a motor vehicle, is specified. The vehicle comprises the driver assistance system according to the embodiments of the present disclosure.

The term vehicle comprises passenger vehicles, trucks, buses, mobile homes, motorcycles, etc. which are used to convey people, goods, etc. In particular, the term comprises motor vehicles for conveying people.

The driver assistance system is configured for automated driving. In particular, automated driving comprises at least the emergency stopping function or carrying out an emergency stop in an automated manner.

The term “automated driving” can be understood in the context of the document as driving with automated longitudinal or lateral guidance or autonomous driving with automated longitudinal and lateral guidance. The automated driving can involve, for example, driving for a longer time on the freeway or driving for a limited time in the context of parking or maneuvering. The term “automated driving” comprises automated driving with an arbitrary degree of automation. Exemplary degrees of automation are assisted, semiautomated, highly automated, or fully automated driving. These degrees of automation were defined by the Bundesanstalt für Straβenwesen [German Federal Highway Research Institute] (BASt) (see BASt publication “Forschung kompakt [compact research]”, issue 11/2012).

In assisted driving, the driver continuously executes the longitudinal or lateral guidance, while the system takes over the respective other function in certain limits. In semiautomated driving (SAD), the system takes over the longitudinal and lateral guidance for a certain period of time and/or in specific situations, wherein the driver has to continuously monitor the system as in assisted driving. In highly automated driving (HAD), the system takes over the longitudinal and lateral guidance for a certain period of time without the driver having to continuously monitor the system; however, the driver has to be capable of taking over the vehicle control in a certain time. In fully automated driving (FAD), the system can automatically manage the driving in all situations for a specific application; a driver is no longer necessary for this application.

The above-mentioned four degrees of automation correspond to the SAE levels 1 to 4 of the norm SAE J3016 (SAE—Society of Automotive Engineering). Furthermore, SAE level 5 is also provided as the highest degree of automation in SAE J3016, which is not included in the definition of the BASt. SAE level 5 corresponds to driverless driving, in which the system can automatically manage all situations like a human driver during the entire journey; a driver is generally no longer required.

According to a further independent aspect of the present disclosure, a driver assistance method for a vehicle, in particular a motor vehicle, is specified. The driver assistance method comprises receiving a user input to deactivate an emergency stopping function; determining a driver status; and reactivating the deactivated emergency stopping function if the driver status corresponds to a predetermined status.

The driver assistance method can implement the aspects of the driver assistance system described in this document.

According to at least one aspect of the present disclosure, a software (SW) program is specified. The SW program can be configured to be executed on one or more processors and to thus carry out the driver assistance method, described in this document, for a vehicle.

According to at least one aspect of the present disclosure, a storage medium is specified. The storage medium can comprise an SW program, which is configured to be executed on one or more processors and to thus carry out the driver assistance method, described in this document, for a vehicle.

According to at least one aspect of the present disclosure, software having program code for carrying out the driver assistance method for a vehicle is to be executed when the software runs on one or more software-controlled devices.

According to at least one aspect of the present disclosure, a system for a vehicle is specified. The system comprises one or multiple processors; and at least one memory which is connected to the one or the multiple processors and contains instructions which can be executed by the one or the multiple processors in order to carry out the driver assistance method, described in this document, for a vehicle.

A processor or a processor module is a programmable execution unit, thus a machine or an electronic circuit, which controls other elements according to transferred commands and advances an algorithm (process) in this case.

Exemplary embodiments of the disclosure are shown in the figures and are described in more detail hereinafter.

### BRIEF DESCRIPTION OF THE DRAWINGS

FIG. 1 schematically shows a vehicle having a driver assistance system for automated driving according to embodiments of the present disclosure,

FIG. 2 schematically shows a driver assistance system according to embodiments of the present disclosure,

FIG. 3 schematically shows a vehicle having a driver assistance system according to embodiments of the present disclosure, and

FIG. 4 shows a flow chart of a driver assistance method according to embodiments of the present disclosure.

### DETAILED DESCRIPTION OF THE DRAWINGS

If not indicated otherwise, identical reference signs are used for identical and identically-acting elements hereinafter.

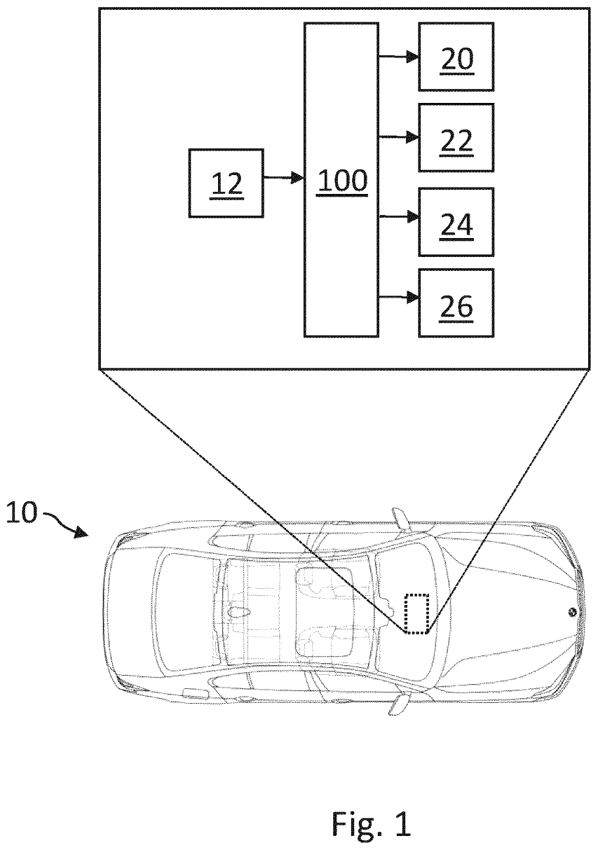

FIG. 1 schematically shows a vehicle 10 having a driver assistance system 100 for automated driving according to embodiments of the present disclosure.

In automated driving, the longitudinal and/or lateral guidance of the vehicle 10 is carried out automatically. The driver assistance system 100 thus takes over the vehicle guidance. For this purpose, the driver assistance system 100 controls the drive 20, the transmission 22, the hydraulic service brake 24, and the steering system 26 via intermediate units (not shown).

To plan and carry out the automated driving, surroundings information of a surroundings sensor system which observes the vehicle surroundings is received by the driver assistance system 100. In particular, the vehicle can comprise at least one surroundings sensor 12 configured to record surroundings data which specify the vehicle surroundings. The at least one surroundings sensor 12 can comprise, for example, one or more lidar systems, one or more radar systems, one or more laser scanners, one or more ultrasonic sensors, and/or one or more cameras.

The driver assistance system 100 is configured to carry out an emergency stop. An emergency stop is an autonomous driving maneuver of the vehicle 10 in order to bring the vehicle 10 to a standstill, for example on a shoulder or on the roadside. The emergency stop is triggered in this case if at least one trigger condition is met. For example, the at least one trigger condition can comprise a detected sleeping status, a faint, a medical emergency, an operation of a switch by the driver or another passenger, etc.

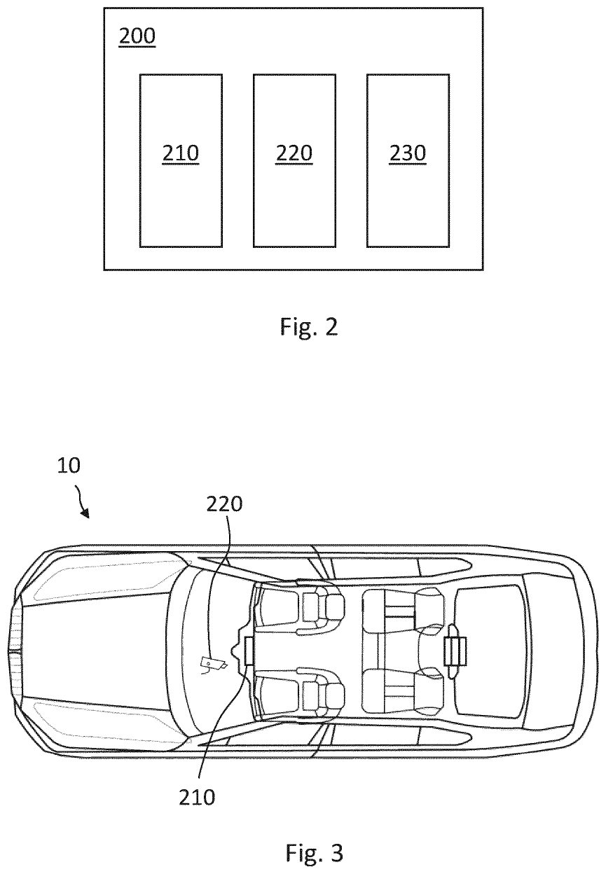

FIG. 2 schematically shows a driver assistance system 200 according to embodiments of the present disclosure. FIG. 3 schematically shows a vehicle 10 having the driver assistance system 200 of FIG. 2.

The driver assistance system 200 comprises a user interface module 210 configured to receive a user input to deactivate an emergency stopping function; a driver monitoring module 220 configured to determine a driver status; and a control module 230 configured to reactivate the deactivated emergency stopping function if the driver status corresponds to a predetermined status.

The driver monitoring module 220 and the control module 230 can be implemented in a common software and/or hardware module. Alternatively thereto, the driver monitoring module 220 and the control module 230 can each be implemented in separate software and/or hardware modules.

The user interface module 210 can in some embodiments be a central information output and information input device of an infotainment system, such as a head unit. The user interface module 210 typically comprises a touchscreen, which enables both an information output and a reception of user inputs by touches.

The driver monitoring module 220 can in some embodiments comprise at least one sensor, such as a camera, in particular an interior camera. The driver monitoring module 220 can optionally comprise at least one light source. The light source can in some embodiments be an infrared light source, and the at least one sensor can be an infrared sensor, such as an infrared camera. The driver monitoring module 220 is configured to evaluate the registered data provided by the at least one sensor, such as image data. The status of the driver, such as a fatigue, is registrable or determinable by the evaluation of the registered data.

If the driver monitoring module 220 recognizes that the driver is fatigued, the emergency stopping function previously deactivated manually by the driver can be reactivated. In some embodiments, the activation of the emergency stopping function can be optically and/or acoustically indicated to the driver by means of the user interface module 210. Optionally, a notification of the detected fatigue can also be given to the driver and, for example, a break can be recommended.

In exemplary embodiments, the reactivation of the emergency stopping function can take place based on feedback by the driver. For example, the driver can be queried optically and/or acoustically by means of the user interface module 210 whether the emergency stopping function is to be reactivated. The request for a confirmation of the activation can take place, for example, when only a slight fatigue is detected.

Alternatively, the reactivation of the emergency stopping function can take place automatically without participation of the driver. The automatic activation without request for a confirmation of the activation can take place, for example, if a strong fatigue, faint, or sleep is detected.

The reactivation of the emergency stopping function can take place only for the current driving cycle or, for example, permanently for this driver or this driver profile. In some embodiments, the driver can be queried optically and/or acoustically by means of the user interface module 210 whether the emergency stopping function is to be activated only for the current driving cycle or permanently for this driver profile. In other embodiments, the control module 230 can decide without participation of the driver whether the emergency stopping function is to be activated only for the current driving cycle or permanently for this driver profile.

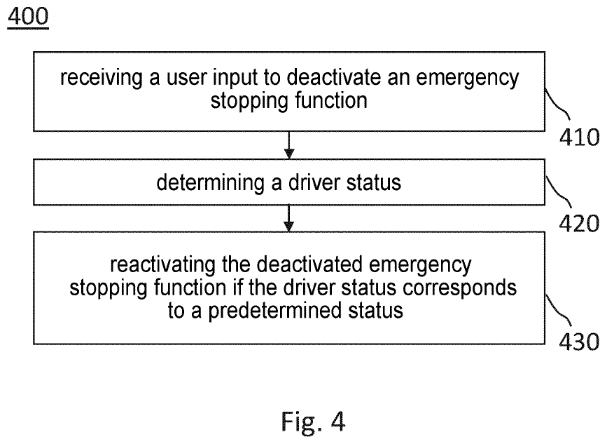

FIG. 4 schematically shows a flow chart of a driver assistance method 400 according to embodiments of the present disclosure. The driver assistance method 400 can be implemented by corresponding software which is executable by one or more processors (such as a CPU).

The driver assistance method 400 comprises, in block 410, receiving a user input to deactivate an emergency stopping function; in block 420, determining a driver status; and in block 430, reactivating the deactivated emergency stopping function if the driver status corresponds to a predetermined status.

The emergency stopping function is therefore activated or armed in the background in specific situations, even if the driver has previously deactivated the emergency stopping function. For example, if the driver has been detected as very fatigued, the emergency stopping function can be automatically activated or armed counter to the driver input. As a result, a functional readiness of the emergency stopping function can be maximized, by which potential hazardous situations in road traffic, such as collisions with other road users and/or obstacles, can be avoided.

Although the invention was illustrated and explained in more detail by preferred exemplary embodiments, the invention is not restricted by the disclosed examples and other variations can be derived therefrom by a person skilled in the art without departing from the scope of protection of the invention. It is therefore clear that a variety of possible variations exist. It is also clear that embodiments mentioned as examples really only represent examples which are not to be interpreted in any way as limiting, for example, the scope of protection, the possible applications, or the configuration of the invention. Rather, the preceding description and the description of the figures make a person skilled in the art capable of specifically implementing the exemplary embodiments, wherein a person skilled in the art, with knowledge of the disclosed concept of the invention, can perform manifold modifications, for example, with respect to the function or the arrangement of individual elements mentioned in an exemplary embodiment without departing from the scope of protection defined by the claims and their legal equivalents, such as more extensive explanations in the description.

1-10. (canceled)

11. A driver assistance system for a vehicle, comprising:
a user interface module configured to receive a user input to deactivate an emergency stopping function;
a driver monitoring module configured to determine a driver status; and
a control module configured to reactivate the deactivated emergency stopping function if the driver status corresponds to a predetermined status.

12. The driver assistance system of claim 11, wherein the user interface module is configured:
to output a request to reactivate the emergency stopping function if the driver status corresponds to the predetermined status; and
to reactivate the emergency stopping function if a user input to reactivate the emergency stopping function is received as a response to the request.

13. The driver assistance system of claim 11, wherein the control module is configured to reactivate the deactivated emergency stopping function automatically if the driver status corresponds to the predetermined status.

14. The driver assistance system of claim 11, wherein the driver monitoring module is configured to determine a measure of the driver status, and wherein the control module is configured to carry out the reactivation of the emergency stopping function based on the measure of the driver status.

15. The driver assistance system of claim 14, wherein the control module is configured:
to output the request to reactivate the emergency stopping function if the measure of the driver status corresponds to a first measure, in particular wherein the first measure is a first fatigue status of the driver; and
to reactivate the deactivated emergency stopping function automatically if the measure of the driver status corresponds to a second measure which is higher than the first measure, in particular wherein the second measure is a second fatigue status of the driver.

16. The driver assistance system of claim 11, wherein:
the driver monitoring module is configured for a long-term observation of the driver; and
the control module is configured to carry out the reactivation of the emergency stopping function based on the long-term observation of the driver.

17. The driver assistance system of claim 11, wherein the control module is configured:
to reactivate the emergency stopping function for a current driving cycle and to deactivate it again for a driving cycle following the current driving cycle; or to reactivate the emergency stopping function permanently for this driver.

18. A motor vehicle comprising the driver assistance system of claim 11.

19. A driver assistance method for a vehicle, the method comprising:
receiving a user input to deactivate an emergency stopping function;
determining a driver status; and
reactivating the deactivated emergency stopping function if the driver status corresponds to a predetermined status.

20. A non-transitory storage medium storing software program executable by one or more processors to carry out the driver assistance method of claim 19.
